(19) United States
(12) Patent Application Publication
(10) Pub. No.: US 2025/0008573 A1
(43) Pub. Date: Jan. 2, 2025

(54) DYNAMIC RESERVATION OF LINKS FOR SUPPORTING LOW-LATENCY IN UNLICENSED SPECTRUM

(71) Applicant: Nokia Technologies Oy, Espoo (FI)

(72) Inventors: Silvio MANDELLI, Stuttgart (DE); Lorenzo GALATI GIORDANO, Stuttgart (DE); Mika KASSLIN, Espoo (FI); Zhijie YANG, Shanghai (CN)

(21) Appl. No.: 18/693,051

(22) PCT Filed: Sep. 26, 2021
(86) PCT No.: PCT/CN2021/120544

§ 371 Date: Mar. 18, 2024

(51) Int. Cl. H04W 74/0833; H04L 43/0876; H04W 64/00

(52) U.S. Cl. CPC H04W 74/085; H04L 43/0876; H04W 64/00

(57) ABSTRACT

Embodiments of the present disclosure relate to devices, methods, apparatuses and computer readable storage media of dynamic reservation of links for supporting low latency in unlicensed spectrum for improved system performance. The method comprises determining a probability associated with one or more available links of the first device; transmitting the probability to a second device; and receiving an indication of the number of links that need to be left free for a communication within a cluster at which the first device is located. In this way, a certain probability of successful listen-before-talk (LBT) can be guaranteed for the time-sensitive/URLLC traffic. A minimum number of links that should be left can be configured as always free for allowing time-sensitive/low latency packets to find a transmission opportunity over these links with a certain probability and be transmitted immediately, therefore the probability of successful LBT can be effectively manipulated, which may addresses private industrial deployments.

### FIELD

Embodiments of the present disclosure generally relate to the field of telecommunication and in particular to devices, methods, apparatuses and computer readable storage media of dynamic reservation of links for supporting low latency in unlicensed spectrum.

### BACKGROUND

For Wi-Fi products operating in the unlicensed spectrum, channel access mechanisms, such as listen before talk (LBT), may introduce very small delay in unloaded network conditions. However, when the network is loaded, the channel access delay may become unpredictable. This has to do with the back-off mechanism associated to the LBT procedure.

Therefore, the Wi-Fi may not be typically considered as a suitable technology for delivering critical communications with deterministic or stringent constraints in latency, like time-sensitive network (TSN) communication or Ultra-reliable and Low Latency Communications (URLLC).

### SUMMARY

In general, example embodiments of the present disclosure provide a solution of dynamic reservation of links for supporting low latency in unlicensed spectrum.

In a first aspect, there is provided a first device. The first device comprises at least one processor; and at least one memory including computer program codes; the at least one memory and the computer program codes are configured to, with the at least one processor, cause the first device at least to determine a probability associated with one or more available links of the first device; transmit the probability to a second device; and receive an indication of the number of links that need to be left free for a communication within a cluster at which the first device is located.

In a second aspect, there is provided a second device. The second device comprises at least one processor; and at least one memory including computer program codes; the at least one memory and the computer program codes are configured to, with the at least one processor, cause the second device at least to receive, from a first device, a probability associated with one or more available links of the first device; determine, at least based on the probability, the number of links that need to be left free for a communication within a cluster at which the first device is located; and transmit an indication of the number of links to the first device.

In a third aspect, there is provided a method. The method comprises determining a probability associated with one or more available links of the first device; transmitting the probability to a second device; and receiving an indication of the number of links that need to be left free for a communication within a cluster at which the first device is located.

In a fourth aspect, there is provide a method. The method comprises receiving, from a first device, a probability associated with one or more available links of the first device; determining, at least based on the probability, the number of links that need to be left free for a communication within a cluster at which the first device is located; and transmitting an indication of the number of links to the first device.

In a fifth aspect, there is provided an apparatus comprising means for determining a probability associated with one or more available links of the first device; means for transmitting the probability to a second device; and means for receiving an indication of the number of links that need to be left free for a communication within a cluster at which the first device is located.

In a sixth aspect, there is provided an apparatus comprising means for receiving, from a first device, a probability associated with one or more available links of the first device; means for determining, at least based on the probability, the number of links that need to be left free for a communication within a cluster at which the first device is located; and means for transmitting an indication of the number of links to the first device.

In a seventh aspect, there is provided a computer readable medium having a computer program stored thereon which, when executed by at least one processor of a device, causes the device to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a signaling chart illustrating a process of dynamic reservation of links for supporting low latency in unlicensed spectrum according to some example embodiments of the present disclosure;

FIG. 3 shows a time diagram of a process of dynamic reservation of links for supporting low latency in unlicensed spectrum according to some example embodiments of the present disclosure;

FIG. 4 shows a flowchart of an example method of dynamic reservation of links for supporting low latency in unlicensed spectrum according to some example embodiments of the present disclosure;

FIG. 5 shows a flowchart of an example method of dynamic reservation of links for supporting low latency in unlicensed spectrum according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system. More specifically, the term “communication network” herein refers to Wi-Fi and New Radio Unlicensed (NR-U).

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

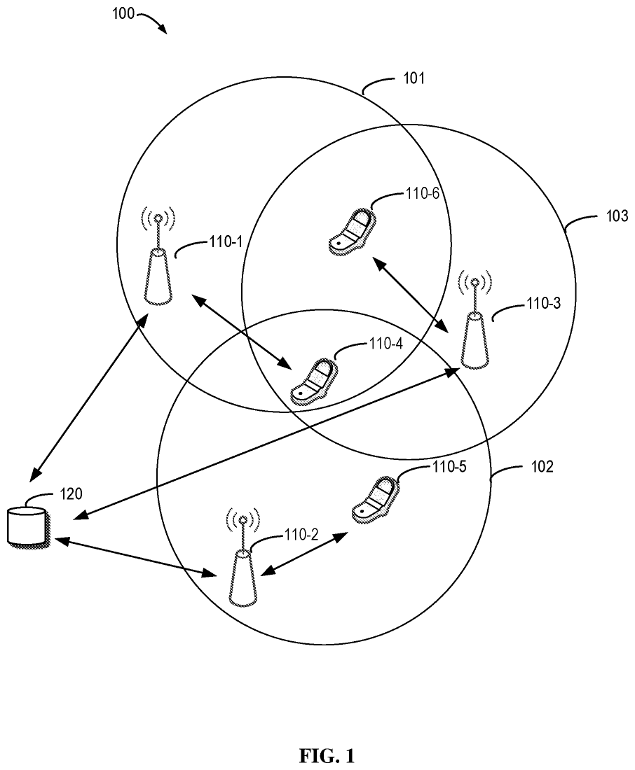

FIG. 1 shows an example communication network 100 in which embodiments of the present disclosure can be implemented. As shown in FIG. 1, the communication network 100 may comprise transmitting devices 110-1, 110-2, 110-3, 110-4, 110-5 and 110-6 (hereinafter may be referred to as a first device 110 or a Wi-Fi device 110 collectively). The transmitting devices may be referred to different types. For example, the transmitting devices 110-1, 110-2 and 110-3 may be referred to as multiple access points. For example, the transmitting devices 110-4, 110-5 and 110-6 may be referred to as terminal devices. The multiple access points may communicate with the terminal devices in their coverages. For example, the transmitting device 110-1 may communicate with the terminal device 110-4 in the coverage 101, the transmitting device 110-2 may communicate with the terminal device 110-5 in the coverage 102 and the transmitting device 110-3 may communicate with the terminal device 110-6 in the coverage 103. It is to be understood that the access points 110-1, 110-2 and 110-3 may also communicate with other devices in their coverages.

The communication network 100 may also comprise a central controller 120 (hereinafter may be referred to as a second device 120), which can act as a management node or a management entity of the communication network 100.

It is to be understood that the number of access points and terminal devices shown in FIG. 1 is given for the purpose of illustration without suggesting any limitations. The communication network 100 may include any suitable number of network devices and terminal devices.

As described above, the Wi-Fi may not be typically considered as a suitable technology for delivering critical communications with deterministic or stringent constraints in latency, like TSN communication or URLLC.

Currently, TSN communication or URLLC are of great importance for industrial vertical scenarios. The Wi-Fi products, especially Wi-Fi 6 and the future Wi-Fi 7 based on the ongoing IEEE 802.11be standardization effort, are looking with increasing interest at ways for supporting time sensitive/low-latency stringent requirements.

Current Wi-Fi 6 Access Point (AP) products have the possibility to operate simultaneously in multiple spectrum bands, i.e., 2.4, 5 and 6 GHz with the possibility to distribute the network load. Moreover, they also have the possibility to aggregate a certain number of channels for increasing the transmission bandwidth.

In addition, 802.11be task group (TGbe) is currently developing the next major PHY&MAC release of the 802.11 specification. One of the main features defined by the TGbe is multi-link, according to which an AP or a non-AP STA that supports 802.11be multi-link can simultaneously manage multiple links working in different channels/bands. The Multi-link capable devices may be referred to as multi-link devices (MLD) and a multi-link AP may be referred to as AP MLD while a multi-link non-AP STA may be referred to as non-AP MLD. An AP MLD and a non-AP MLD may, as an example, establish three links which may operate simultaneously or in cooperate to improve certain transmission parameters. One of the links may be made available to operate in 2.4 GHz, and other link may be available to operate in 5 GHz and third in 6 GHz, respectively. This was also possible with Wi-Fi 6 and previous generations of Wi-Fi products, but the operation in the different links was treated in an independent way, as the selection of the link(s) was performed in the association phase rather that at each transmission opportunities.

An MLD device has the capability to transmit or receive on multiple links within or outside the same spectrum band. This additional feature will give the possibility to significantly increase the usable bandwidth or exploit the degrees of freedom introduced by the high number of accessible links to decrease the channel access delay alternatively. For example, according to the buffer status or the Quality of Service (QoS) requirements, an MLD may dynamically decide to occupy a certain number of links or all links for increasing the transmission bandwidth or use only one link at a time to leave available the highest number of links for other transmissions.

In TSN and URLLC scenario, the packets arrive in the buffers and need to be transmitted and received within a certain stringent time deadline. In Wi-Fi, the channel access procedure should be most luckily successful at the first attempt. Otherwise, the control over packet delay cannot be guaranteed.

Current Wi-Fi products have means for semi-statically distributing the load among the available carrier bands and for steering a certain category of traffic over one of them. But this may not guarantee the support of a required targeted latency. Moreover, they can aggregate a certain number of channels to increase the bandwidth and offer better support to the transmission of broadband traffic. However, applying a greedy band aggregation e.g., in one Basic Service Set (BSS) may have the side effect of reducing the probability of finding interference free channels for devices in other Overlapping BSS (OBSS), thus potentially reducing the capability to support low latency applications.

Upcoming Wi-Fi MLD capable devices will extend the possibility to sense and perform channel access in multiple links at the same time and then decide to use only the link(s) that they consider more appropriate or the link(s) that have been signalled to be available.

However, when MLDs with heavy broadband traffic are deployed within the same coverage area of URLLC/TSN MLDs, they may decide, in absence of any allocation rule, to occupy all the available links for transmitting their large packets thus not leaving free channels at the moment when URLLC/TSN packets arrive in the buffer of other MLD operating on the same channels and need to be transmitted. This could force the low-latency packets to buffer in the queue till the Clear Channel Assessment (CCA) procedure is successful in at least one of the available links. This back-off, which is a part of the CCA procedure of the Wi-Fi protocol, is source of unpredictable delay, which badly couples with the nature of time-sensitive/low-latency communications.

This problem is particularly severe in dense scenarios with, for example, many Full HD security streaming cameras, sensors, AR/VR applications like for example the ones present in Industry 4.0 deployments. Even if the use of Multi-link may introduce more degrees of freedom when searching for a free channel, which may partially mitigate this problem, the Wi-Fi devices may need to keep under control the number of links that should be left free to allow critical low latency communications to access the available radio resources as quickly as possible.

Therefore, the present disclosure provides solutions of dynamic reservation of links for supporting time-sensitive/URLLC in unlicensed spectrum. In this solution, a device may determine a probability associated with having one or more available links and transmit the probability to a central controller. The device may also receive an indication of the number of links that need to be left free for a communication within a cluster within which the device is located.

In this way, a certain probability of successful listen-before-talk (LBT) can be guaranteed for the time-sensitive/URLLC traffic. A minimum number of links that should be left as free can be configured for allowing time-sensitive/low latency packets to find a transmission opportunity on these links, with a certain probability, and be transmitted immediately, which may addresses private industrial deployments and therefore the probability of successful LBT can be effectively manipulated.

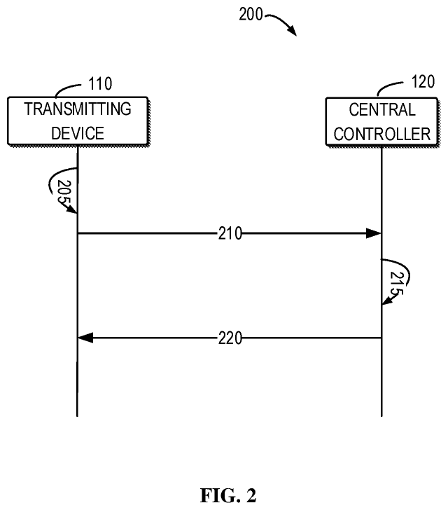

Principle and implementations of the present disclosure will be described in detail below with reference to FIG. 2, which shows a signaling chart illustrating a process 200 of dynamic reservation of links for supporting low latency in unlicensed spectrum according to some example embodiments of the present disclosure. For the purpose of discussion, the process 200 will be described with reference to FIG. 1. The process 200 may involve the transmitting device 110 and the central controller 120 as shown in FIG. 1. Hereinafter the transmitting device 110 may also be referred to as the Wi-Fi device i.

The CSMA/CA protocol adopted by Wi-Fi ensures that any transmission does not overlap with other ongoing ones. The 802.11 specification defines a physical carrier sense mechanism to determine if a channel or link is busy. This mechanism is performed constantly by all the Wi-Fi radios that are not transmitting or receiving, or that are not in sleep mode. In this scenario, it can be assumed that the transmitting device 110 or the terminal device may sense the occupancy status of all the links in which they can operate.

According to IEEE 802.11be, each AP MLD may contain a certain number of AP operating in one or a multitude of the available links. Similarly, a non-AP MLD may also contain a certain number of STA operating in one or a multitude of the available links. Thus, in the context of IEEE 802.11be multi-link framework, the device 110 may be considered as either the AP MLD or the non-AP MLD.

As shown in FIG. 2, the transmitting device 110 may determine 205 a probability associated with one or more available links of the transmitting device 110. In some example embodiments, for each Wi-Fi device i, within a cluster c, the probability bᵢ to see less than R free links to transmit may be computed by the equation (1) as below:

$${b}_{i} = P ( {F}_{i} < R ) , ∀ i ∈ {𝒥}_{c} \qquad ( 1 )$$

where [symbol] may be represented as a set of all Wi-Fi devices, [symbol] ⱼ may be represented as a set of all Wi-Fi devices belonging to a cluster c, a cluster may be a set of devices that need to exchange information between them and take coordinated decisions and F_{I} may be represented as instantaneous number of free links seen by a Wi-Fi device i∈ [symbol] .

The probability bᵢ may represent a snapshot of all the links conditions within a Wi-Fi device i. This probability can be measured and smoothed/tracked by each device with various techniques such as, for example, moving average or exponential smoothing.

After determining the probability, the transmitting device 110 may transmit 210 the probability to the central controller 120.

Then the central controller 120 may determine 215 the number of links that need to be left free for a communication within a cluster at which the transmitting device 110 is located.

In some example embodiments, assume that for each cluster c, the central controller 120 may aggregate the reported measurements obtained at each Wi-Fi device i (also referred as device 110 in FIG. 2). The probability bᵢ is different for each Wi-Fi device, as links are independently occupied. Here a Wi-Fi device can be a MLD that aggregates information of all links of the Wi-Fi device. Each Wi-Fi device may experience a different network load and link occupancy.

For a generic cluster c, it is proposed that every Wi-Fi device can be configured to leave at least k_{c}, with 0≤k_{c}≤L, free links when transmitting the traffic, where L may be represented as the number of available links within each Wi-Fi device.

As long as there is active traffic, choosing to leave free k_{c}≥R links to generate a decrease of bᵢ, ∀i∈l_{c}. This comes from the proposal of introducing the constraint in the cluster that a Wi-Fi device should occupy only L−k_{c} links when transmitting non time sensitive traffic (e.g. broadband traffic).

Therefore, in principle, according to the value of k_{c}, n_{c}=[k_{c}/R] multiple parallel URLLC/TSN transmissions from different Wi-Fi devices could be possible in the cluster with the desired back-off rate b*. However, the value of k_{c} should not be set to be unnecessary high, to avoid generating throughput reduction for the traffic.

In some example embodiments, the central controller 120 may determine the number of links that need to be left free for a communication within a cluster based on the probability associated with one or more available links of the transmitting device 110 received from the transmitting device 110.

For example, the value of the number of links that need to be left free k_{c} can be determined based on the currently estimated bᵢ, ∀i∈ [symbol] _{c} received at the central controller 120. Alternatively, the value k_{c} can also be updated based on an updated bᵢ.

An initial value for k_{c} can be set. For example, the value of k_{c} can be initialized to be equal to k₀, where k₀ can be set to k₀=0 or k₀=R.

Based on the input bᵢ, ∀i∈ [symbol] _{c}, the controller 120 may check whether the desired back-off rate b* is matched by the current experienced one b.

In an option, the current experienced one \hat{b} can be compute it by averaging the measures bᵢ over the whole set [symbol] _{c} or the set [symbol] _{c}^{(URLLC)} where [symbol] _{c}^{(URLLC)} may be represented as a set of Wi-Fi devices with URLLC traffic, with the desire of transmitting short packets on 1≤R≤L links, with a desired back-off probability b*.

Alternatively, the current experienced one b can be computed by considering the minimum value of bᵢ over the whole set [symbol] _{c} or the set [symbol] _{c}^{(URLLC)}.

If the controller 120 determines that \hat{b}=b*, the current k_{c} can be kept. If the the controller 120 determines that \hat{b}<b*, the value of k_{c} can be lowered. If the controller 120 determines that \hat{b}>b*, the value of k_{c} can be increased.

Furthermore, there is another approach for the controller 120 to determine the number of links that need to be left free for a communication within a cluster at which the transmitting device 110 is located. For example, at the initialization phase, a generic node i∈ [symbol] _{c} can be considered relying on the queueing theory.

An arrival rate of hearable URLLC traffic by i can be modelled as below:

$${h}_{i} = {\sum }_{h ∈ {ℋ}_{i}} {λ}_{h}^{( URLLC )} \qquad ( 2 )$$

where λᵢ^{(URLLC)} can be represented URLLC load of Wi-Fi device i, [symbol] can be represented as a set of devices whose transmission can be heard by Wi-Fi device i.

Therefore, assuming that the available links for non time sensitive traffic (e.g. broadband traffic) are always used, the usage of links available for URLLC transmission can be modelled as a M/M/n_{c}/n_{c} system. If the service rate can be estimated as μ, the signalled bᵢ can be coupled with the probability that the queue system is full when a new service arrives in the system.

In some example embodiments, if the arrival rate of URLLC hᵢ can be obtained, then enough free servers n_{c} for the system can be provided and the loss probability can be given by the Erlang B formula, which is a formula that describes the probability of call losses for a group of identical parallel resources (telephone lines, circuits, traffic channels, or equivalent).

If the arrival rates of URLLC hᵢ cannot be obtained, the URLLC load seen by the Wi-Fi device i can be estimated as ρᵢ=hᵢ/ρ. Following the derivations with the usage of links available for URLLC transmission modelled as a M/M/n_{c}/n_{c}, the Erlang-B formula can be represented as

$${b}_{i} = B ( {n}_{c} , {ρ}_{i} ) = \frac{\frac{{ρ}_{i}^{{n}_{c}}}{{n}_{c} !}}{{\sum }_{j = 0}^{{n}_{c}} \frac{{ρ}_{i}^{j}}{j !}} \qquad ( 3 )$$

Based on the equation (3), the URLLC load ρᵢ is allowed to be estimated by bᵢ computed with a certain n_{c}. Thus, the desired average blocking probability can be matched by tuning n_{c}, hence k_{c}=Rn_{c}. It is to be understood that his procedure allows to control the blocking probability of each single device, allowing to match also other KPIs, like the maximum blocking probability of all users in the cluster.

The above mentioned procedure is considered in a case where n_{c} servers are available. However, it is also to be understood that non time sensitive traffic (e.g. broadband traffic) is not always active, resulting in an effectively higher number of available servers. This may lead to an underestimate of ρᵢ.

Nevertheless, the capacity of the system to support TSN/URLLC requirements will not be changed. Because this capacity itself will be achieved by saturating resources reserved to non time sensitive traffic (e.g. broadband traffic), enforced by using a high enough k_{c}. Therefore, the underestimation of ρᵢ mentioned above can be removed.

Referring back to FIG. 2, after determining the number of links that need to be left free, the controller 120 may transmit 220 an indication of the number of links to the transmitting device 110.

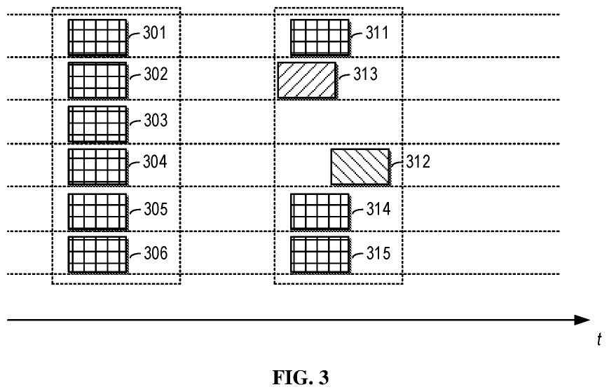

FIG. 3 shows a time diagram of a process of dynamic reservation of links for supporting low latency in unlicensed spectrum according to some example embodiments of the present disclosure. With reference to FIG. 3, the process of dynamic reservation of links can be further explained in detail.

In a case where multiple access points (for example the access points 110-1, 110-2 and 110-3 as shown in FIG. 1 having overlapping coverage areas, for example, where the access point 110-1 may have broadband packets to transmit such as Ultra HD streaming camera, while the access points 110-2 and 110-3 may have TSN/URLLC packets with stringent constraints in terms of delivery time.

For example, as shown in FIG. 3, without using the solution of the present disclosure, all links may be occupied by the access point 110-3 to transmit packets 301-306. If other access points intend to transmit packets, the transmission can be blocked due to the lack of links.

By using the proposed solutions, some of the links can always be left free for the transmitting device in a cluster and each of access points 110-1, 110-2 and 110-3 may have opportunity to transmit TSN/URLLC packets. As shown in FIG. 3, for example, the access point 110-1 may transmit the packet 313, the access point 110-2 may transmit the packets 312, while the access point 110-3 may transmit packets 311, 314 and 315.

In this way, a certain probability of successful LBT can be guaranteed for the time-sensitive/URLLC traffic. A minimum number of links that should be left as free can be configured as for allowing time-sensitive/low latency packets to find a transmission opportunity over these links with a certain probability and be transmitted immediately, which may addresses private industrial deployments and therefore the probability of successful LBT can be effectively manipulated.

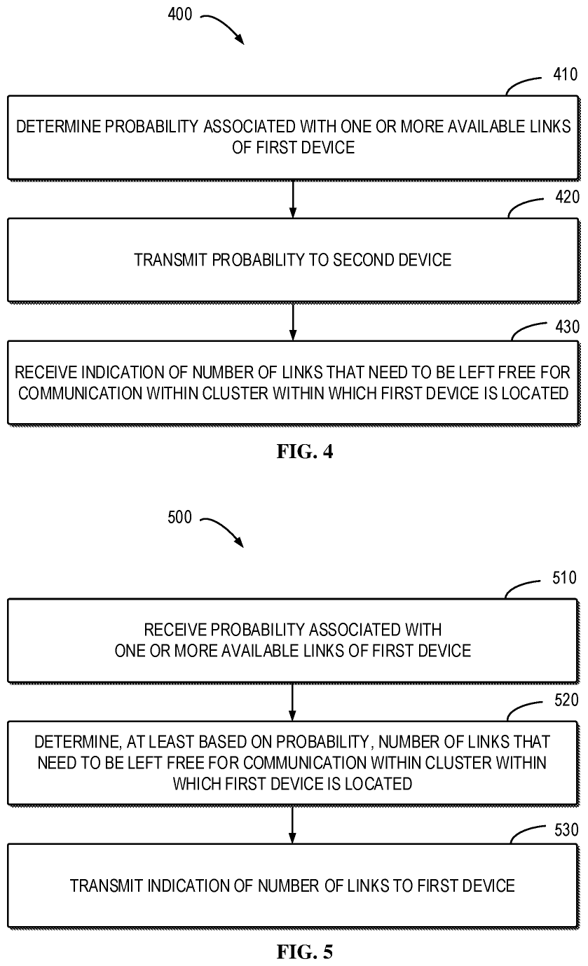

FIG. 4 shows a flowchart of an example method 400 of dynamic reservation of links for supporting low latency in unlicensed spectrum according to some example embodiments of the present disclosure. The method 400 can be implemented at the first device 110 as shown in FIG. 1. For the purpose of discussion, the method 400 will be described with reference to FIG. 1.

At 410, the first device determines a probability associated with one or more available links of the first device.

At 420, the first device transmits the probability to a second device.

At 430, the first device receives an indication of the number of links that need to be left free for a communication within a cluster at which the first device is located.

In some example embodiments, the probability associated with the one or more available links of the first device indicating a probability that the number of the one or more available links is less than the threshold number.

FIG. 5 shows a flowchart of an example method 500 of dynamic reservation of links for supporting low latency in unlicensed spectrum according to some example embodiments of the present disclosure. The method 500 can be implemented at the second device 120 as shown in FIG. 1. For the purpose of discussion, the method 500 will be described with reference to FIG. 1.

At 510, the second devices receive, from a first device, a probability associated with one or more available links of the first device.

At 510, the second devices determine, at least based on the probability, the number of links that need to be left free for a communication within a cluster at which the first device is located.

In some example embodiments, the second device may obtain a reference number of links that need to be left free for the communication among the cluster, determine, based on the probability, a relationship between a desire back-off rate for the communication among the cluster and a current experienced back-off rate, the back-off rate being associated with a blocking probability that the communication is blocked due to unavailable links; and determine the number of links that need to be left free based on the reference number and the relationship.

In some example embodiments, the reference number of links is equal to zero or the number of the one or more available links of the first device.

In some example embodiments, if the second device determines that the current experienced back-off rate is equal to the desire back-off rate, the second device may determine the reference number as the number of links that need to be left free.

In some example embodiments, if the second device determines that the current experienced back-off rate is lower than the desire back-off rate, the second device may determine the number of links that need to be left free by decreasing the reference number.

In some example embodiments, if the second device determines that the current experienced back-off rate is larger than the desire back-off rate, the second device may determine the number of links that need to be left free by increasing the reference number.

In some example embodiments, the second device may determine an association between the probability associated with one or more available links of the first device and the reference number of allowable parallel transmissions in the cluster; determine a desire number of the allowable parallel transmissions in the cluster based on the association and a desired blocking probability for the communication among the cluster; and determine the number of links that need to be left free based on the desire number of the allowable parallel transmissions in the cluster.

In some example embodiments, the second device may determine a traffic load in the cluster observable for the first device and determine the association based on the traffic load and a Erlang-B formula.

In some example embodiments, the second device may determine an arrival rate of a traffic associated with the communication among the cluster for the first device; and determine the association based on the arrival rate, a service rate for the communication and a Erlang-B formula.

In some example embodiments, an apparatus capable of performing the method 400 (for example, implemented at the transmitting device 110) may comprise means for performing the respective steps of the method 400. The means may be implemented in any suitable form. For example, the means may be implemented in a circuitry or software module.

In some example embodiments, the apparatus comprises means for determining a probability associated with one or more available links of the first device; means for transmitting the probability to a second device; and means for receiving an indication of the number of links that need to be left free for a communication within a cluster at which the first device is located.

In some example embodiments, an apparatus capable of performing the method 500 (for example, implemented at the controller 120) may comprise means for performing the respective steps of the method 500. The means may be implemented in any suitable form. For example, the means may be implemented in a circuitry or software module.

In some example embodiments, the apparatus comprises means for receiving, from a first device, a probability associated with one or more available links of the first device; means for determining, at least based on the probability, the number of links that need to be left free for a communication within a cluster at which the first device is located; and means for transmitting an indication of the number of links to the first device.

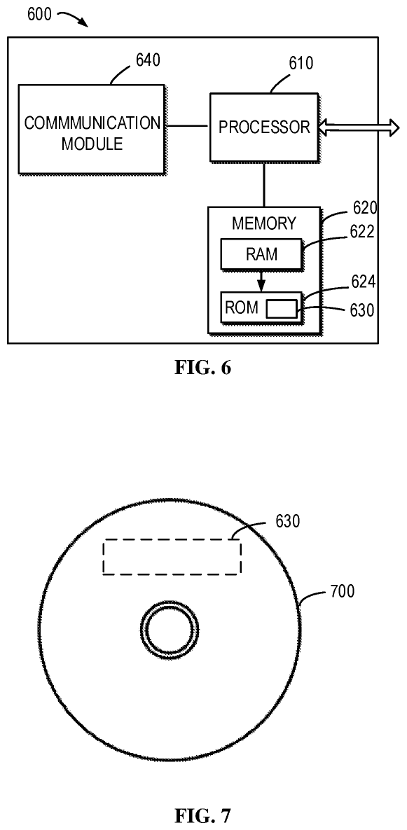

FIG. 6 is a simplified block diagram of a device 600 that is suitable for implementing embodiments of the present disclosure. The device 600 may be provided to implement the communication device, for example the device 110 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 620. The processor 610 may perform any suitable actions and processing by loading the program 630 into the RAM 620.

The embodiments of the present disclosure may be implemented by means of the program 630 so that the device 600 may perform any process of the disclosure as discussed with reference to FIGS. 2 to 5. The embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 400 and 500 as described above with reference to FIGS. 4-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-25. (canceled)

26. A first device comprising:
at least one processor; and
at least one memory including computer program codes;
the at least one memory and the computer program codes are configured to, with the at least one processor, cause the first device at least to:
determine a probability associated with one or more available links of the first device;
transmit the probability to a second device; and
receive an indication of the number of links that need to be left free for a communication within a cluster at which the first device is located.

27. The first device of claim 26, wherein the probability associated with the one or more available links of the first device indicating a probability that the number of the one or more available links is less than the threshold number.

28. A second device comprising:
at least one processor; and
at least one memory including computer program codes;
the at least one memory and the computer program codes are configured to, with the at least one processor, cause the second device at least to:
receive, from a first device, a probability associated with one or more available links of the first device;
determine, at least based on the probability, the number of links that need to be left free for a communication within a cluster at which the first device is located; and
transmit an indication of the number of links to the first device.

29. The second device of claim 28, wherein the second device is caused to determine the number of links that need to be left free by:
obtaining a reference number of links that need to be left free for the communication among the cluster;
determining, based on the probability, a relationship between a desire back-off rate for the communication among the cluster and a current experienced back-off rate, the back-off rate being associated with a blocking probability that the communication is blocked due to unavailable links; and
determining the number of links that need to be left free based on the reference number and the relationship.

30. The second device of claim 29, wherein the reference number of links is equal to zero or the number of the one or more available links of the first device.

31. The second device of claim 29, wherein the second device is caused to determine the number of links that need to be left free based on the reference number and the relationship by:
in accordance with a determination that the current experienced back-off rate is equal to the desire back-off rate, determining the reference number as the number of links that need to be left free.

32. The second device of claim 29, wherein the second device is caused to determine the number of links that need to be left free based on the reference number and the relationship by:
in accordance with a determination that the current experienced back-off rate is lower than the desire back-off rate, determining the number of links that need to be left free by decreasing the reference number.

33. The second device of claim 29, wherein the second device is caused to determine the number of links that need to be left free based on the reference number and the relationship by:
in accordance with a determination that the current experienced back-off rate is larger than the desire back-off rate, determining the number of links that need to be left free by increasing the reference number.

34. The second device of claim 28, wherein the second device is caused to determine the number of links that need to be left free by:
determining an association between the probability associated with one or more available links of the first device and the reference number of allowable parallel transmissions in the cluster;
determining a desire number of the allowable parallel transmissions in the cluster based on the association and a desired blocking probability for the communication among the cluster; and
determining the number of links that need to be left free based on the desire number of the allowable parallel transmissions in the cluster.

35. The second device of claim 34, wherein the second device is caused to determine the association by:
determining a traffic load in the cluster observable for the first device;
determining the association based on the traffic load and a Erlang-B formula.

36. The second device of claim 34, wherein the second device is caused to determine the association by:
determining an arrival rate of a traffic associated with the communication among the cluster for the first device;
determining the association based on the arrival rate, a service rate for the communication and a Erlang-B formula.

37. A method by a first device comprising:
determining a probability associated with one or more available links of the first device;
transmitting the probability to a second device; and
receiving an indication of the number of links that need to be left free for a communication within a cluster at which the first device is located.

38. The method of claim 37, wherein the probability associated with the one or more available links of the first device indicating a probability that the number of the one or more available links is less than the threshold number.

39. A method by a second device comprising:
receiving, from a first device, a probability associated with one or more available links of the first device;
determining, at least based on the probability, the number of links that need to be left free for a communication within a cluster at which the first device is located; and
transmitting an indication of the number of links to the first device.

40. The method of claim 39, wherein determining the number of links that need to be left free comprises:
obtaining a reference number of links that need to be left free for the communication among the cluster;
determining, based on the probability, a relationship between a desire back-off rate for the communication among the cluster and a current experienced back-off rate, the back-off rate being associated with a blocking probability that the communication is blocked due to unavailable links; and
determining the number of links that need to be left free based on the reference number and the relationship.

41. The method of claim 40, wherein the reference number of links is equal to zero or the number of the one or more available links of the first device.

42. The method of claim 40, wherein determining the number of links that need to be left free based on the reference number and the relationship comprises:
in accordance with a determination that the current experienced back-off rate is equal to the desire back-off rate, determining the reference number as the number of links that need to be left free.

43. The method of claim 40, wherein determining the number of links that need to be left free based on the reference number and the relationship comprises:
in accordance with a determination that the current experienced back-off rate is lower than the desire back-off rate, determining the number of links that need to be left free by decreasing the reference number.

44. The method of claim 40, wherein determining the number of links that need to be left free based on the reference number and the relationship comprises:
in accordance with a determination that the current experienced back-off rate is larger than the desire back-off rate, determining the number of links that need to be left free by increasing the reference number.

45. The method of claim 39, wherein determining the number of links that need to be left free comprises:
determining an association between the probability associated with one or more available links of the first device and the reference number of allowable parallel transmissions in the cluster;
determining a desire number of the allowable parallel transmissions in the cluster based on the association and a desired blocking probability for the communication among the cluster; and
determining the number of links that need to be left free based on the desire number of the allowable parallel transmissions in the cluster.
